(19) United States
(12) Patent Application Publication
(10) Pub. No.: US 2025/0208019 A1
(43) Pub. Date: Jun. 26, 2025

(54) CELL SORTING BASED ON EVENT STATISTICS

(71) Applicant: Life Technologies Corporation, Carlsbad, CA (US)

(72) Inventors: Matthew Meyer, Ft. Collins, CO (US); Daniel Fox, Ft. Collins, CO (US)

(21) Appl. No.: 18/990,290

(22) Filed: Dec. 20, 2024

Related U.S. Application Data
(60) Provisional application No. 63/613,437, filed on Dec. 21, 2023.

(51) Int. Cl. G01N 15/1409; G01N 15/10; G01N 15/14; G01N 35/00

(52) U.S. Cl. CPC G01N 15/1409; G01N 15/1425; G01N 35/00722; G01N 2015/1028; G01N 2035/00544; G01N 2035/0091

(57) ABSTRACT

Methods and apparatuses of determining sorting efficiency for sorted particles. One method includes acquiring event statistics based on one or more signals generated from interrogating the particles in a fluid stream. The method also includes determining a degree of deviation of the event statistics from reference statistics and taking an automated responsive action in response to the degree of deviation exceeding a threshold level.

### RELATED APPLICATIONS

This application claims priority to U.S. Provisional Application No. 63/613,437 filed Dec. 21, 2023, the entire content of which is incorporated herein by reference.

### TECHNICAL FIELD

Various examples relate generally to flow cytometry and/or cell sorting.

### BACKGROUND

Cell sorting is a process of physical separation of a target cell population from a heterogeneous mixture of cells. Example cell sorting techniques include Magnetic Activated Cell Sorting (MACS) and electrostatic cell sorters. MACS uses magnetic particles bound to cells through an antibody interaction with surface markers of the cells. Interaction of the bound particles with an external magnetic field is then used to separate the targeted cells from the rest of the biological sample. Electrostatic cell sorters separate a population of cells into subpopulations based on scatter and fluorescent labeling. Fluorescence measurements taken at different wavelengths are used to distinguish different fluorescent markers, thereby enabling cell separation into different bins based on the individual cell's fluorescence signal (or lack thereof). The efficiency of cell sorting through MACS or with electrostatic cell sorters typically depends on many parameters. In at least some cases, navigating the parameter space to find satisfactory or nearly optimal conditions for cell sorting may present a significant challenge.

### SUMMARY

Disclosed herein are, among other things, various examples, aspects, features, and embodiments for systems and methods configured to obtain a fast and accurate estimate of the sorting efficiency based on the event statistics acquired by optically interrogating, for a relatively short period of time, a stream carrying a suspension of the cells being sorted. When the estimated sorting efficiency is deemed to be too low, an electronic controller may automatically pause the sorting operations to request a user intervention or may autonomously make one or more changes via one or more control signals applied to various components thereof. Because the event statistics can be acquired relatively quickly, an example embodiment of the disclosed systems and methods beneficially enables more-efficient and better-guided searches for satisfactory or nearly optimal cell-sorting conditions within the parameter space of cell-culturing conditions, and sample-preparation conditions.

One example provides a method for sorting particles, the method comprising: with a computing device, acquiring event statistics based on one or more signals generated from interrogating the particles in a fluid stream; with the computing device, determining a degree of deviation of the event statistics from reference statistics; and with the computing device, taking an automated responsive action in response to the degree of deviation exceeding a threshold level.

Another example provides an apparatus comprising: a fluidics system configured to generate a fluid stream using a sample including a suspension of particles to be sorted, the fluid stream forming a stream of droplets; an optical interrogation system configured to illuminate the fluid stream with probe light and one or more optical detectors configured to convert optical response signals to the probe light received from the fluid stream into electrical signals; and an electronic controller configured to: process the electrical signals to acquire event statistics corresponding to the fluid stream; determine a degree of deviation of the event statistics from reference statistics; and take a responsive action in response to the degree of deviation exceeding a threshold level.

Yet another example provides a non-transitory computer-readable medium storing instructions that, when executed by a computing device, cause the computing device to perform operations comprising: acquiring event statistics based on one or more signals generated from interrogating particles in a fluid stream; determining a degree of deviation of the event statistics from reference statistics; and taking an automated responsive action in response to the degree of deviation exceeding a threshold level.

### BRIEF DESCRIPTION OF THE DRAWINGS

The foregoing aspects and many of the attendant advantages of the present disclosure will become more readily appreciated as the same become better understood by reference to the following detailed description, when taken in conjunction with the accompanying drawings.

FIG. 1A is a flowchart illustrating a control method performed via a computing device associated with the system illustrated in FIG. 1B according to some examples.

FIG. 1B is a block diagram illustrating a system having a cell-sorting capability according to some examples.

FIGS. 2A-2B are histograms graphically illustrating event gaps observed in the system of FIG. 1B for two different samples according to some examples.

FIG. 3 is a graph representation of the histograms shown in FIGS. 2A and 2B according to one example.

FIG. 4 is a graph providing a comparison of the event statistics observed in the system of FIG. 1B for two Chinese hamster ovary (CHO) cell samples according to some examples.

FIG. 5 is a graph illustrating a correlation between the sorting efficiency and the fraction of fast events observed in the system of FIG. 1B according to some examples.

FIG. 6 is a bar plot illustrating a correlation between the levels of root mean square (RMS) noise of the sorting efficiency, event rate, and arrival statistics observed in the system of FIG. 1B according to some examples.

FIG. 7 is a flowchart of a sorting method implemented in the system of FIG. 1B according to some examples.

FIG. 8 is a block diagram of an example computing device that can be used to implement the methods of FIGS. 1A and 7 or portions thereof in accordance with various embodiments.

### DETAILED DESCRIPTION

Cell sorting efficiency can be quantified using a ratio of the number of target cells sorted into a proper bin to the total number of processed target cells. When the sorting criteria are not met, the cell sorter prevents droplet deflection, which is the process that physically moves individual cells into a designated cells recovery location (bin). For example, the sorting criteria may not be met when two or more cells are “too close” together. Factors that might cause the cells to be too close together include, but are not limited to, clumping, sticky cells, and unfavorable drop spacing.

For instance, a cell sorter can process over one hundred thousand events per second, and each of those events can be indexed, catalogued, and tracked based on the droplet index. This information can be exploited to improve cell sorting efficiency. For example, a theoretical efficiency of cell sorting can be estimated based on the Poisson statistics. Deviations from the Poisson statistics may provide insights into how the system is performing compared to the theoretically estimated efficiency. For example, the distribution of time intervals separating cell arrival events can be used to calculate the number of “fast” events that do not follow the Poisson statistics. The percentage of such fast events can then be correlated with the cell preparation and culturing conditions and with certain configuration parameters of the system. The conditions and/or configuration parameters can then be adjusted to beneficially shift the performance characteristics of the system closer to an optimal efficiency.

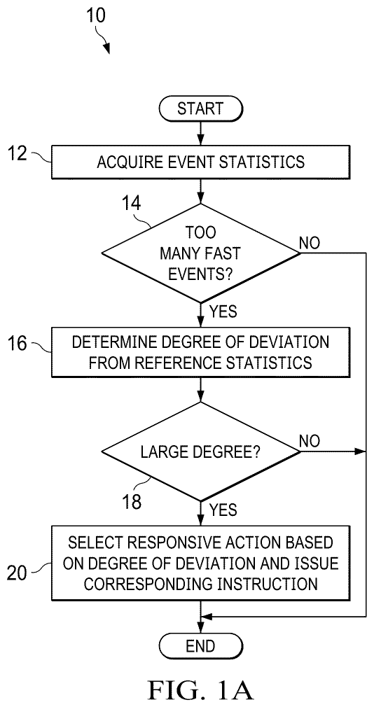

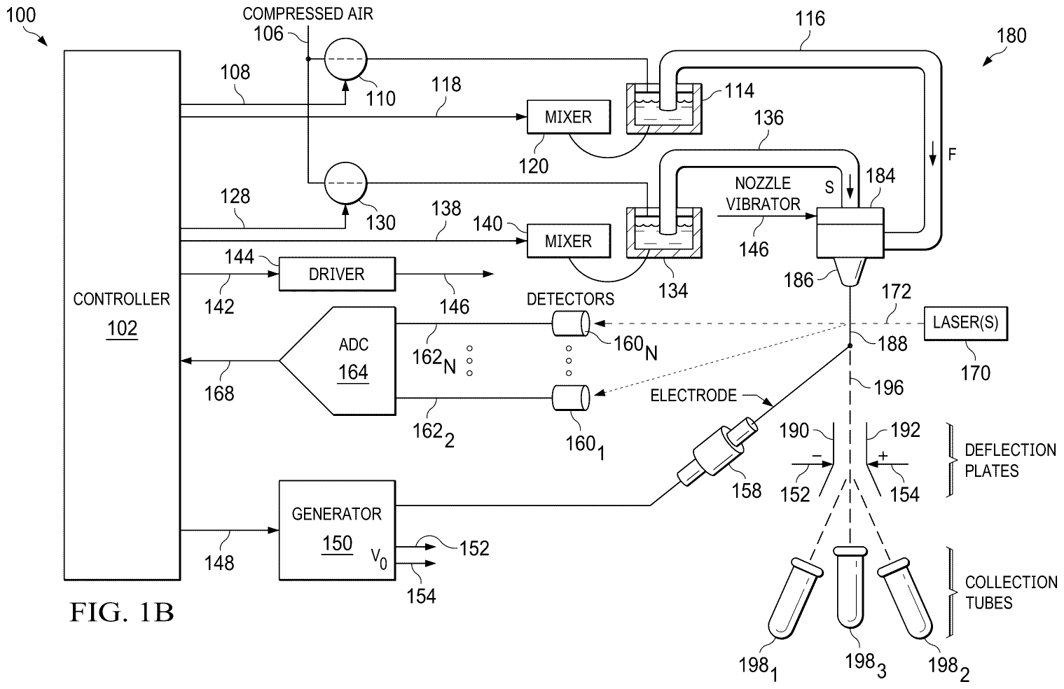

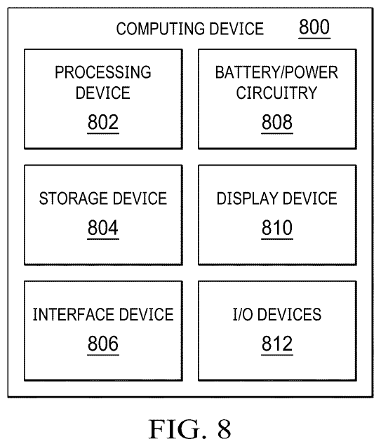

FIG. 1A is a flowchart illustrating a control method 10 performed via a computing device associated with a system 100 according to some examples. The system 100 is described in more detail below in reference to FIG. 1B. In some examples, the computing device that executes the control method 10 is a part of an electronic controller of the system 100. In some examples, the computing device that executes the control method 10 is implemented as described below in reference to FIG. 8.

The method 10 includes the computing device acquiring event statistics (in a block 12). In some examples, the event statistics is acquired based on one or more signals generated and detected within the system during optical interrogation of a stream of fluid. In some cases, the stream of fluid includes a suspension of particles. As an example, particles may include cells.

The method 10 also includes the computing device determining whether the fraction of fast events is too large (in a decision block 14). In some examples, this determination in the decision block 14 is made by comparing the fast-event fraction value with a threshold value. When the fast-event fraction value is smaller than the threshold value (“No” at the decision block 14), the method 10 is terminated. When the fast-event fraction value is greater than or equal to the threshold value (“Yes” at the decision block 14), the method 10 proceeds to perform operations of a block 16.

Operations of the block 16 include the computing device determining a degree of deviation of the event statistics from the reference statistics. In some examples, the reference statistics is Poisson statistics. In some examples, such determining includes (i) fitting a distribution of event gaps to a sum including a first component characterized by a first-rate parameter and a second component characterized by a second rate parameter that is greater than the first rate parameter and (ii) determining a fraction of the distribution corresponding to the second component.

The method 10 also includes the computing device comparing the degree of deviation with a threshold level (in a decision block 18). When the degree of deviation is smaller than the threshold level (“No” at the decision block 18), the method 10 is terminated. When the degree of deviation is greater than or equal to the threshold level (“Yes” at the decision block 18), the method 10 proceeds to perform operations of a block 20.

Operations of the block 20 include the computing device selecting an automated responsive action and issuing a corresponding set of instructions to pertinent components of the system 100. In some examples, the responsive action comprises the computing device communicating through a user interface a suggested change in the sample or in a configuration of the system. In some examples, the responsive action comprises the computing device generating one or more controls signals directed to the pertinent components of the system 100 without the user intervention. After the operations of the block 20 are completed, the method 10 is terminated.

FIG. 1B is a block diagram illustrating a system 100 having a cell-sorting capability according to some examples. The system 100 may include a fluidics system 180 including a sample container 134 configured to inject a sample S, via a sample injection hose 136, into a central core of a nozzle 186. The sample S typically contains a suspension of cells or particles in a carrier fluid. The diameter of the sample injection hose 116 is significantly larger than the size of the cells or particles in the sample S. As a result, the cells or particles of the sample S are initially distributed substantially randomly in the corresponding volume of the central core of the nozzle 186. To force the sample S from the sample container 134 into the sample injection hose 136, the sample container 134 is pressurized with compressed air delivered, through a pressure regulator 130, from a compressed air supply line 106.

Peripheral portions of the nozzle 186 receive a flow of a sheath fluid F, via a sheath fluid injection hose 116, from a sheath-fluid container 114. To force the sheath fluid F from the sheath fluid container 114 into the sheath fluid injection hose 116, the sheath fluid container 114 is pressurized with compressed air delivered, through a pressure regulator 110, from the compressed air supply line 106. Due to the narrowing of the nozzle 186, the velocity of the sheath fluid F increases along the downstream direction in the nozzle 186. The flow of the sample S is focused into the center of the nozzle 186 due to the Bernoulli effect associated with the velocity change such that the cells or particles of the sample S approach the exit aperture of the nozzle 186 substantially in single file. Under optimal flow conditions (e.g., with laminar flow), there is substantially no mixing in of the sheath fluid F into the central stream that carries the sample S.

A vibrator 184, driven with a drive signal 146 generated by a driver circuit 144, vibrates the nozzle 186 to facilitate breaking up of an output stream 188 ejected from the nozzle 186 into droplets 196. In an example implementation, the vibrator 184 includes a piezoelectric crystal. The drive signal 146 typically has a suitably selected frequency, e.g., in the ultrasonic range. The frequency and the amplitude of the drive signal 146 can be optimized for efficient formation of droplets of a suitable size and can be adjusted as needed via a control signal 142 applied by an electronic controller 102 to the driver circuit 144.

The output stream 188 ejected from the nozzle 186 passes through one or more laser beams 172 generated by one or more laser sources 170. Each of the laser sources 170 emits light at a respective wavelength, which can be in the spectral range from ultraviolet to infrared (depending on the specific embodiment and configuration of the system 100 and on the fluorescent markers used with the sample S). Light scattering and fluorescence emission generated in the output stream 188 in response to the one or more laser beams 172 is detected using a plurality of optical detectors 160₁-160_{N}. Electrical output signals 162₁-162_{N} generated by the optical detectors 160₁-160_{N} are converted into digital form in an analog-to-digital converter (ADC) 164. Resulting digital signals 168 are then directed to the electronic controller 102 for processing.

In some examples, one of the optical detectors 160₁-160_{N} is configured to detect light scattered in the forward direction, such as, for example, at an angle that is smaller than approximately 20° with respect to the laser beam axis. An output of this optical detector is typically referred to as the forward scatter channel (FSC). The FSC data can be used, for example, to estimate the size of the light scattering cells or particles in the stream 188. Another one of the optical detectors 160₁-160_{N} is typically configured to detect light scattered at approximately 90° with respect to the laser beam axis. The corresponding output is typically referred to as the side scatter channel (SSC). The SSC data can be used to provide information about the relative complexity (for example, granularity and internal structure) of the cells or particles of the sample S. Based on a combination of FSC and SSC data, the cells/particles can be differentiated, such as, for example, by cell types and sizes.

Additional one or more of the optical detectors 160₁-160_{N} are configured for fluorescence measurements. In an example configuration, the fluorescent light is collected at approximately 90° with respect to the laser beam axis and is directed to a corresponding optical detector 160ₙ through one or more respective beam splitters and optical filters (not explicitly shown in FIG. 1B). The combination of optical filters is such that each of the corresponding optical detectors 160ₙ receives light that is spectrally within a different respective wavelength band.

When a cell or particle passes through the optical interrogation spot, a pertinent set of the optical detectors 160₁-160_{N} will generate electrical pulses. These pulses in the corresponding set of the output signals 162₁-162_{N} manifest to the electronic controller 102 the passage of a cell or particle through the laser beam 172. As explained above, different ones of the optical detectors 160₁-160_{N} will report on the scattered (FSC and SSC) light and on the fluorescence light. As the cell or particle enters the optical interrogation spot, the output of the corresponding optical detector will begin to rise, reaching a peak when the cell or particle is located approximately in the center of the laser beam 172. At this point, the cell or particle is brightly and fully illuminated (the laser beam 172 typically has the highest intensity in the center portion thereof) and will produce a strongest optical signal. As the cell or particle moves away from the center of the laser beam 172, the optical signal will drop back to the baseline. This generation of an optical pulse is defines an “event.” The electronic controller 102 operates to put a time stamp on each event and record one or more pertinent characteristics of the corresponding pulse, such as, for example, the amplitude, width, an integrated area of the pulse, or a combination thereof.

A measurement from each optical detector 160_{N} provides a respective event parameter. Each event parameter can be displayed according to its amplitude, area, and width values on histograms and dot plots using appropriate data-processing software. Tens or even hundreds of thousands of cells per second can be examined in this manner based on their event parameters. A combination of event parameters provides an event “signature,” which can be used for performing various sorting operations explained in more detail below. For illustration purposes and without any implied limitations, three-way sorting performed with the system 100 is described below. Based on the provided description, a person of ordinary skill in the pertinent art will readily understand how to make and use system embodiments designed for sorting cells into a different (smaller or greater than three) number of sorting bins.

In the example illustrated, the three sorting bins are implemented using collection tubes 198₁-198₃. The collection tube 198₁ is configured to receive a first type of cells present in the sample S. The collection tube 198₂ is configured to receive a second type of cells present in the sample S. The collection tube 198₃ operates as a waste collector. For each event, the electronic controller 102 compares the event signature with a set of reference signatures including a first reference signature corresponding to the first type of cells and a second reference signature corresponding to the second type of cells. When the event signature matches the first reference signature, the electronic controller 102 uses a control signal 148 to configure a voltage generator 150 to apply a positive pulse to an electrode 158, which imparts a positive charge onto the corresponding portion of the stream 188. When the event signature matches the second reference signature, the electronic controller 102 uses the control signal 148 to configure the voltage generator 150 to apply a negative pulse to the electrode 158, which imparts a negative charge onto the corresponding portion of the stream 188. When the event signature does not match the first reference signature or the second reference signature, the electronic controller 102 uses the control signal 148 to configure the voltage generator 150 not to apply a charge pulse to the corresponding portion of the stream 188. The imparted charges cause the corresponding droplets 196 to be charged accordingly after the stream 188 breaks up into droplets.

The voltage generator 150 also has output terminals 152, 154 that are connected to deflection plates 190, 192, respectively. For the sorting operations, the voltage generator 150 applies a high voltage V₀ between the output terminals 152, 154 with the indicated polarity. The applied voltage polarity causes the deflection plate 190 to be negatively charged and further causes the deflection plate 192 to be positively charged. The positively charged droplets 196 are deflected toward the negatively charged plate 190 and are captured by the appropriately positioned collection tube 198₁. The negatively charged droplets 196 are deflected toward the positively charged plate 192 and are captured by the appropriately positioned collection tube 198₂. The uncharged droplets 196 pass between the plates 190, 192 undeflected and are captured by the centrally positioned collection tube 198₃.

In addition to the above-mentioned control signals 142 and 148, the electronic controller 102 generates control signals 108, 118, 128, and 138. The control signal 108 controls the pressure setting of the pressure regulator 110. As such, the air pressure in the sheath-fluid container 114 can be changed by the electronic controller 102 via the control signal 108. A change in the air pressure in the sheath-fluid container 114 typically results in a change of the flow rate of the sheath fluid F into the nozzle 186. The control signal 128 similarly controls the pressure setting of the pressure regulator 130. As such, the air pressure in the sample container 134 can be changed by the electronic controller 102 via the control signal 128. A change in the air pressure in the sample container 134 typically results in a change of the flow rate of the sample S into the nozzle 186. Changing the flow rates affects the sample and sheath-fluid flows through the nozzle 186 and, as such, the distribution of the cells or particles of the sample S in the output stream 188.

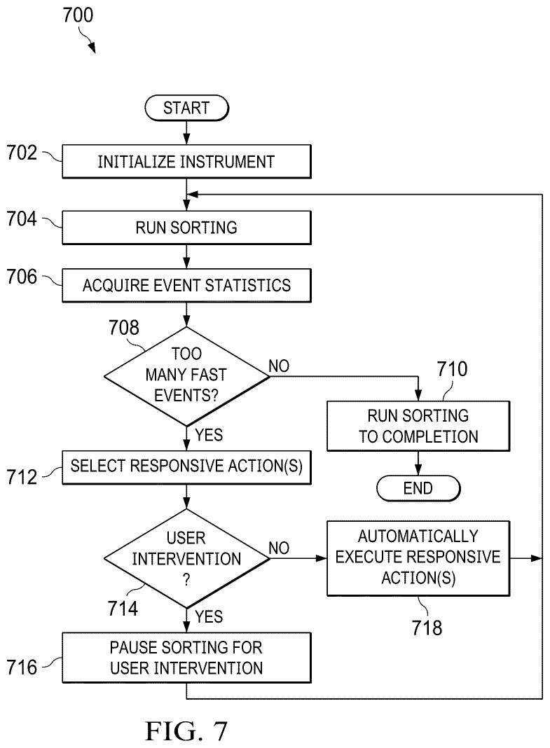

The control signal 138 controls sample handling operations performed in a sample mixer 140 connected to the sample container 134. The control signal 138 can be used, for example, to cause the sample mixer 140 to: (i) withdraw a selected volume of the sample S from the sample container 134; (ii) process the withdrawn volume of the sample S, such as, for example, by performing one or more processing operations therewith; and (iii) transfer the resulting processed volume of the sample S back into the sample container 134. The processing operations of sample mixer 140 may be configured to do one or more of the following: (i) change a relative fraction of one or more subpopulations of the cells, such as, for example, reduce a relative fraction of sticky cells; (ii) reduce the occurrence of clumping; (iii) add a detergent or surfactant; (iv) change the overall concentration of cells or particles; (v) change the composition of the carrier fluid or buffer; (vi) change pH or the like, or (vii) a combination thereof. One or more of these operations may be performed when a responsive action is taken by the electronic controller 102 in response to a degree of deviation of the event statistics from reference statistics exceeding a threshold level (also see block 718, FIG. 7).

In some examples, the sample mixer 140 includes or is a vortex mixer. In an example vortex mixer, a motor drives an off-center holder in a circular motion to create a vortex, or spiral flow, in the sample vial placed in the holder. In such examples, the control signal 138 can be used to select or deselect vortexing as a mixing mode and to specify the rotation speed for the motor. In various examples, the programmable motor speed is in the range from about 100 rpm to about 3500 rpm.

The control signal 118 controls sheath fluid handling operations performed in a sheath fluid mixer 120 connected to the sheath fluid container 114. The control signal 118 can be used, for example, to cause the sheath fluid mixer 120 to: (i) withdraw a selected volume of the sheath fluid F from the sheath fluid container 114; (ii) process the withdrawn volume of the sheath fluid F, e.g., by performing one or more mixing operations therewith, or replace the withdrawn volume of the sheath fluid F by a corresponding volume of a different sheath fluid; (iii) transfer the resulting volume of the sheath fluid back into the sheath fluid container 114; (iv) or a combination thereof. Example processing operations may be configured to change the composition of the sheath fluid F, such as, for example, the pH of the sheath fluid F, or the like. One or more of these operations may be performed when a responsive action is taken by the electronic controller 102 in response to a degree of deviation of the event statistics from reference statistics exceeding a threshold level (also see block 718, FIG. 7).

In some examples, the event location inside the corresponding droplet 196 is determined with up to 8-bit resolution with appropriate alignment and focusing of the optical beam 172 and based on the peak of the fluorescence signal representing the event. The 8-bit resolution means that the droplet 196 is in effect divided into 256 (=2⁸) slices, and the event is attributed to one of such slices. The capability to track the event locations with a sub-droplet resolution is exploited to provide insights into the quality of the sample S. For example, when the sample S exhibits proper event spacing (event gaps), the corresponding sorting efficiency, viability, purity, and recovery metrics tend to be relatively close to optimal ranges.

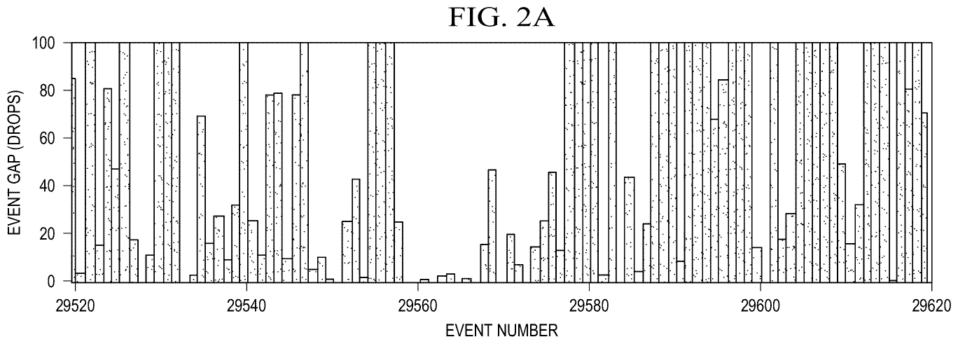

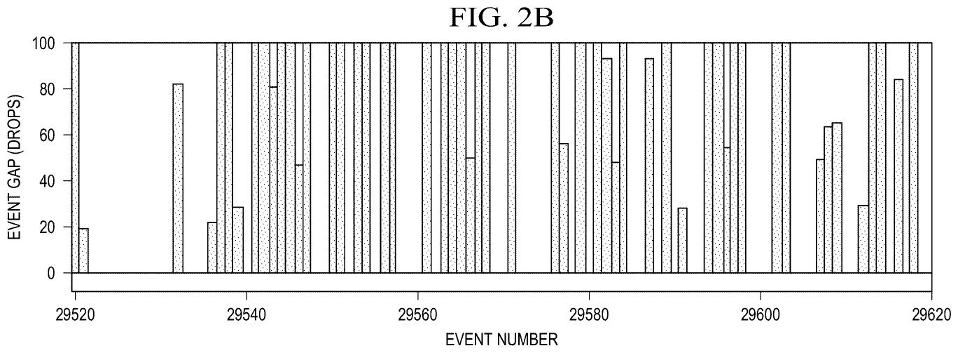

FIGS. 2A and 2B are histograms illustrating event gaps observed in the system 100 for two different samples according to some examples. More specifically, the histogram shown in FIG. 2A corresponds to a suspension of Chinese hamster ovary (CHO) cells with the concentration of 3.0×10⁶ cells/ml. The histogram shown in FIG. 2B corresponds to a suspension of beads with the concentration of 1.0×10⁶ beads/ml. The events represented in the histograms at zero drops between the events are classified by the electronic controller 102 as being coincident. An example sorting mode used in the system 100 is the purity mode with a one drop envelope. In this mode, the target cell of interest will be sorted into the intended collection tube, for example, the collection tube 1981, if no contamination events are present in the droplet envelope. When the corresponding drop contains a “contaminant” manifested by a contamination event within the droplet envelope, that drop will be discarded, such as, for example, by being directed into the collection tube 1983 as described above. In some examples, the larger the number of the discarded droplets 196, the lower the effective sorting efficiency of the system 100.

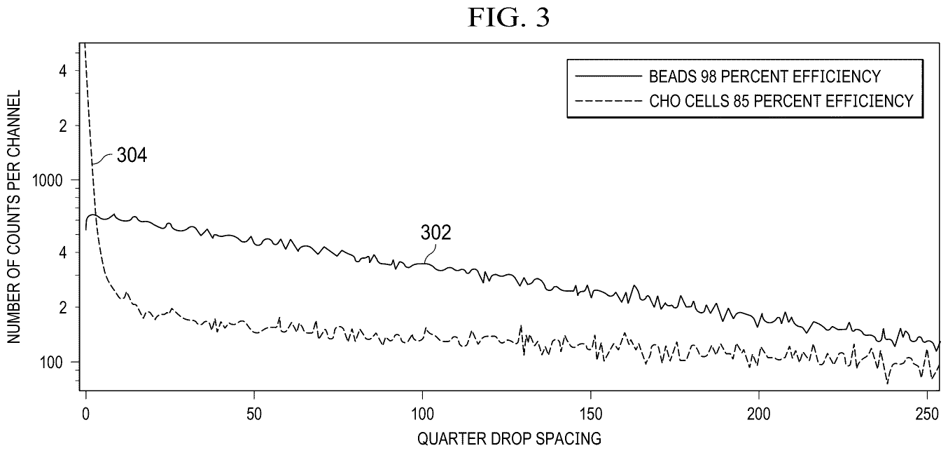

FIG. 3 is a graph representation of the histograms shown in FIGS. 2A and 2B according to one example. The abscissa of the graph shown in FIG. 3 represents event gaps measured in the units of one quarter of a droplet. As noted above, the spatial resolution provided by an example embodiment of the system 100 is 1/256^{th} of a droplet, which is significantly finer than the ¼^{th} of a droplet data-channel width used in FIG. 3. The numerical range of the abscissa is from 0 to 256, which corresponds to a total of 64 droplets past the trigger event. The ordinate of the shown graph represents, on a logarithmic scale, the number of counts for different event-gap data channels. A curve 302 represents the CHO histogram of FIG. 2B. A curve 304 similarly represents the beads histogram of FIG. 2A.

The curve 302 is well fitted with a single exponential distribution expressed as follows:

$$n ( τ ) = κ {e}^{- λ τ} \qquad ( 1 )$$

where τ is the channel number representing the length of the event gap measured in the units of one quarter of a droplet; n (τ) is the number of counts in the τ-th channel; κ is a constant; and λ is the rate parameter. The good fit to Eq. (1) indicates that the curve 302 is relatively close to a Poisson distribution. The corresponding sorting efficiency achieved by the system 100 for the beads sample is correspondingly high, at 98%.

In contrast, the curve 304 cannot be well fitted with Eq. (1) and, as such, deviates significantly from an ideal Poisson distribution. The degree of deviation can be quantified, such as, for example, by fitting the curve 304 to a bimodal distribution and determining the relative weights of its two components. The bimodal distribution can be expressed as follows:

$$n ( τ ) = {κ}_{1} {e}^{- {λ}_{1} τ} + {κ}_{2} {e}^{- {λ}_{2} τ} \qquad ( 2 )$$

where κ₁ and κ₂ are the weights of the two components of the bimodal distribution; and λ₁ and λ₂ are the rate parameters of the two components of the bimodal distribution. By normalizing Eq. (2), the fractions (e.g., expressed as percentages) of the two components of the bimodal distribution can be obtained. The component of the bimodal distribution having the larger rate parameter is deemed to represent a deviation from the Poisson statistics attributed to the “fast” events. In the example shown, the sorting efficiency achieved by the system 100 for the CHO sample is approximately 85%, which is significantly lower than the sorting efficiency of 98% achieved for the beads sample.

In some examples, a multimodal distribution having more than two components can similarly be used to quantify the degree of deviation from an ideal Poisson distribution. A mathematical expression for the multimodal distribution is analogous to Eq. (2) but has a sum of three or more exponential terms. In some cases, different components of the multimodal distribution may be attributable to different respective physical causes contributing to the deviation from an ideal Poisson distribution and, as such, may provide additional guidance to selecting more-precisely targeted corrective actions.

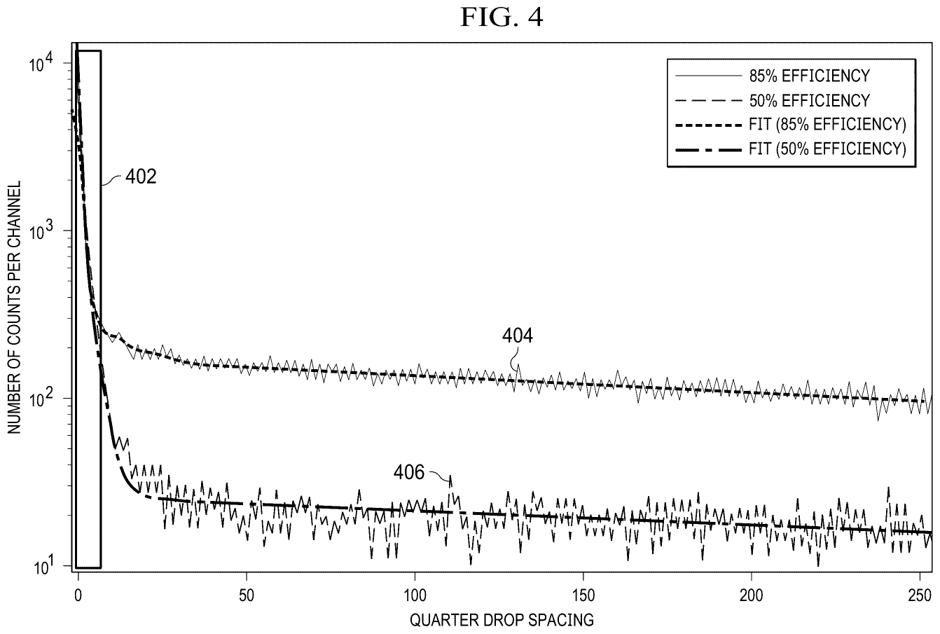

FIG. 4 is a graph providing a comparison of the event statistics observed in the system 100 for two CHO cells samples according to some examples. The graph of FIG. 4 is analogous to the graph of FIG. 3 and is similarly derived from the corresponding event-gaps histograms (not shown; see FIGS. 2A-2B for a qualitative view of such histograms). In the graph of FIG. 4, a box 402 represents one full droplet (=4 quarter droplets). The two CHO cells samples differ in that one of the samples was vortexed at 1200 rpm for ten seconds in the sample mixer 140 whereas the other sample was not. A curve 404 corresponds to the vortexed sample. A curve 406 corresponds to the non-vortexed sample. The numerical fits of the curves 404 and 406 to Eq. (2) are also shown in

FIG. 4 and demonstrate a good description of the experimental data by the bimodal distribution model. The non-vortexed sample has a higher percentage of dead cells and debris than the vortexed sample, which manifests itself in a greater fraction of fast events. According to the shown numerical fits, the fraction of fast events is approximately 9.2% for the vortexed sample and approximately 40% for the non-vortexed sample. The observed sorting efficiencies are 85% and 50%, respectively.

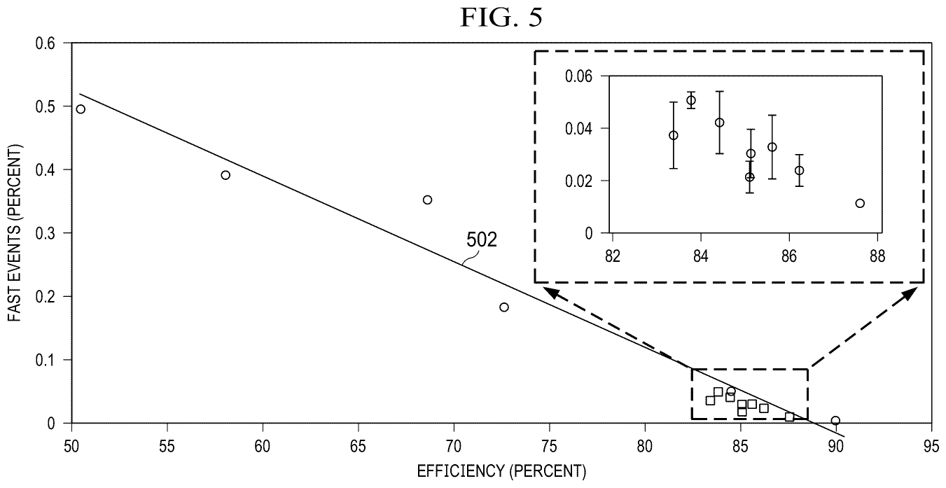

FIG. 5 is a graph further illustrating a correlation between the sorting efficiency and the fraction of fast events observed in the system 100 according to some examples. The inset provides a more-detailed view of the experimental data corresponding to the sorting-efficiency range from 82% to 88%. The solid dots represent experimental data for different samples S. A straight line 502 is a visual guide emphasizing a general trend in the data, according to which a smaller fraction of fast events translates into a higher sorting efficiency. The various samples S represented in the graph of FIG. 5 are samples of CHO cells that differ in concentration and viability. The concentration ranged from one million cells per mL to five million cells per mL, and the viability ranged from 98% to 60%. Cells with lower viability and/or at higher concentration exhibit a higher number of fast events, and cells with higher viability and lower concentration exhibit a lower number of fast events.

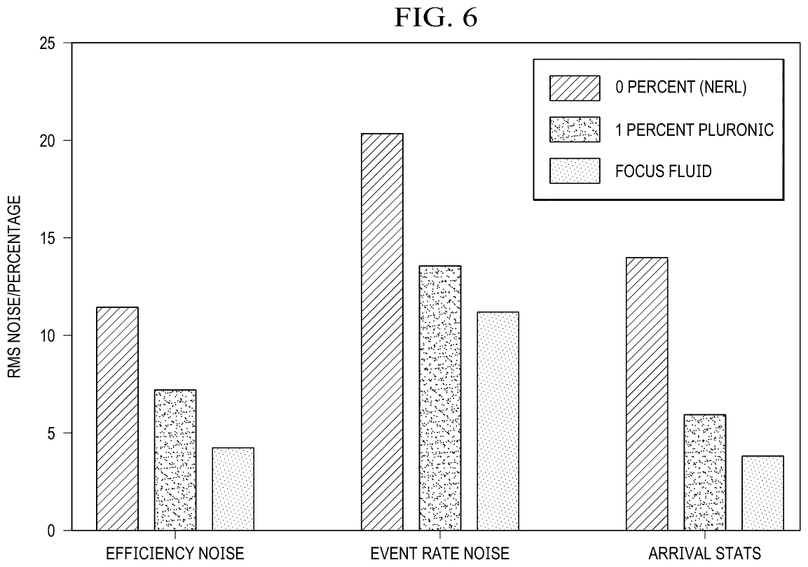

FIG. 6 is a bar plot illustrating a correlation between the levels of root mean square (RMS) noise of the sorting efficiency, event rate, and event statistics observed in the system 100 according to some examples. Results for three samples S of CHO cells that differ in the composition of the carrier fluid are shown. In all three cases, a higher level of the RMS noise in the event statistics is associated with higher levels of the RMS noise in the observed sorting efficiency and event rate. The shown data illustrate that the RMS noise of the event statistics can be used as a guide toward a more stable operation of the system 100, in which more stable event rates and more stable sorting efficiency are achieved.

In various additional examples, the event statistics can be used as a fast and efficient guide to improving the sorting efficiency of the system 100 by providing indicators for changing, adjusting, and/or optimizing one or more of the following group of sample S preparation conditions and configuration parameters of the system 100:
1) composition of the carrier (sample) fluid;
2) composition of the sheath fluid;
3) choice and amount of one or more surfactants or detergents for the carrier fluid and/or the sheath fluid;
4) use of vortexing and/or other selected sample processing operations in the sample mixer 140 and a choice of one or more parameters therefor;
5) frequency and amplitude of the drive signal 146 for the nozzle vibrator 184;
6) air pressure in the containers 114, 134; and
7) diluting the sample to achieve a nearly optimal rate of events per second at a higher flow rate.
   In one example, the above-indicated changes are made when the corresponding system does not execute hard aborts to discard the data corresponding to events in which two cells or particles are too close to one another to be resolved.

FIG. 7 is a flowchart of a sorting method 700 according to some examples. An example embodiment of the sorting method 700 can be executed using control software run on the electronic controller 102. The control software provides a user interface through which the operator of the system 100 receives pertinent information about the sorting process. In some cases, the user interface is used by the operator of the system 100 to provide additional inputs to the electronic controller 102 at certain points of the workflow of the method 700. It should be understood that the method 700 is described herein as being performed via the electronic controller 102. However, in other implementations, the method 700 or portions thereof may be performed by one or more controllers of the system 100, one or more controllers remote from the system 100 and communicatively coupled to the system 100, or a combination thereof.

The method 700 includes initializing the system 100 for processing an intended sample S (in a block 702). Example initialization operations of the block 702 include: (i) specifying the number of sorting bins (e.g., embodied by the collection tubes 198ₖ); (ii) specifying a target sorting efficiency; (iii) specifying a target sorting time, or (iv) a combination thereof. The number of sorting bins typically depends on the nature of the sample S. For example, two collection tubes 198ₖ may be used to sort some CHO cell samples, whereas six collection tubes 198ₖ may be used to sort PBMC samples. Herein, the acronym PBMC stands for Peripheral Blood Mononuclear Cells. PBMCs include lymphocytes (T cells, B cells, and NK cells), monocytes, and dendritic cells. In humans, the frequencies of these populations vary across individuals, but typically, lymphocytes are in the range of 70-90%, monocytes are in the range 10-20%, while dendritic cells are relatively rare, accounting for about 1-2%. In some examples, the target sorting efficiency is specified as a threshold value, with any sorting efficiencies below this threshold value are deemed unacceptable. In some examples, the sorting time may have an impact on the viability of the sorted cells and, as such, may need to be constrained. In additional examples, various other reasons for constraining the sorting time may also be applicable. Additional initialization operations of the block 702 may include (i) loading the sample mixer 140 with appropriate substances and/or fluids with which the sample S is constituted or reconstituted, (ii) loading the sheath-fluid mixer 120 with components from which the sheath fluid is constituted, or (iii) a combination thereof. Some examples of the fluids that may be loaded into the mixers 120, 140 include buffers, surfactants, emulsifiers, etc.

The method 700 also includes the electronic controller 102 starting or resuming sorting of the sample S (in a block 704). Example operations of the block 704 include the electronic controller 102 generating the control signals 108, 118, 128, 138, 142, and 148 to appropriately control the corresponding components of the system 100, e.g., as described above in reference to FIG. 1B.

The method 700 also includes the electronic controller 102 acquiring the event statistics over at least a predetermined amount of time (in a block 706). In some examples, the predetermined statistics-acquisition time is relatively short, for example, between ten seconds and one minute. The event statistics is acquired by the electronic controller 102 in the block 706 based on the corresponding output signals 162₁-162_{N} of the optical detectors 160₁-160_{N} conveyed thereto via the digital signals 142. Example operations of the block 706 may include generating event-gap data based on the timestamps of the various detected events and processing the event-gap data to determine the fraction of fast events. Each of the histograms shown in FIGS. 2A-2B provides an example of the event-gap data that may be generated by the electronic controller 102 in the block 702. In some examples, the fraction of fast events is determined by the electronic controller 102 in the block 706 by fitting the generated event-gap data with a bimodal distribution model as described above in reference to FIGS. 3-4.

The method 700 also includes the electronic controller 102 determining whether the fraction of fast events is too large (in a decision block 708). This determination in the decision block 708 is made by comparing the fast-event fraction value determined in the block 706 with a threshold value. In some examples, the threshold value is derived from the target sorting efficiency specified in the initialization block 702 based on the previously established correlation between the observed sorting efficiency and the observed fraction of fast events. An example of such correlation is shown in FIG. 5. When the fast-event fraction value is smaller than the threshold value (“No” at the decision block 708), the method 700 proceeds to perform operations of a block 710. When the fast-event fraction value is greater than or equal to the threshold value (“Yes” at the decision block 708), the method 700 proceeds to perform operations of a block 712.

Operations of the block 710 include the electronic controller 102 configuring the pertinent components of the system 100 to continue the sorting operations started or resumed in the block 704 to completion, such as, for example, until the entire usable volume of the corresponding sample S has been processed and sorted into the proper collection tubes 198ₖ. Upon completion of the sorting operations of the block 710, the method 700 is terminated.

Operations of the block 712 include the electronic controller 102 selecting a corrective action for the system 100. In a typical example, the selected corrective action is directed at improving the sorting efficiency of the system 100 subject to applicable constrains specified in the initialization block 702. Some corrective actions may require an intervention from the human operator of the system 100. Some other corrective actions may be automatically implemented by the electronic controller 102 without such intervention, such as, for example, via one or more of the control signals 108, 118, 128, 138, 142, and 148. Example corrective actions may be selected from an action list including but not limited to: (i) making changes in the preparation of the cell culture for the sample S; (ii) changing the composition of the carrier fluid; (iii) changing the composition of the sheath fluid; (iv) adding one or more surfactants to the carrier fluid and/or the sheath fluid; (v) activating or deactivating vortexing in the sample mixer 140; (vi) changing the frequency and/or amplitude of the nozzle vibrator 184; and (vii) changing the air pressure in one or both of the containers 114 and 134. In some examples, two or more corrective actions may be available for selection. In such examples, a corrective action estimated to be the most effective in improving the sorting efficiency of the system 100 may be selected first, such as, for example, based on auxiliary information and/or prior sorting data pertaining to the sample S at hand and/or close analogs thereof. In subsequent instances of the block 712 (if any), other corrective actions from the list of possible corrective actions may be selected in the order of being most impactful in terms of the estimated improvement to the sorting efficiency of the system 100 for the sample S. In some examples, two or more corrective actions may be selected in the same instance of the block 712.

The method 700 also includes the electronic controller 102 determining (in a decision block 714) whether the user intervention is needed for the implementation of the corrective action(s) selected in the block 712. In some examples, this determination in the block 714 is made based on prior classification of different corrective actions as either involving or not involving the user intervention. When the electronic controller 102 determines that the user intervention is involved in the corrective action(s) selected in the block 712 (“Yes” at the decision block 714), the method 700 proceeds to perform operations of a block 716. When the electronic controller 102 determines that the user intervention is not involved in the corrective action(s) selected in the block 712 (“No” at the decision block 714), the method 700 proceeds to perform operations of a block 718.

Operations of the block 716 include pausing the sorting operations for the user intervention and communicating through the user interface of the system 100 a corresponding message to the operator. Operations of the block 716 further include receiving through the user interface a confirmation from the operator of the system 100 that the user intervention has been completed. Upon receiving such confirmation, the method 700 is directed back to the block 704, where the electronic controller 102 configures the system 100 to resume the sorting of the sample S.

Operations of the block 718 include the electronic controller 102 automatically

implementing the corrective action(s) selected in the block 712, such as, for example, via one or more of the control signals 108, 118, 128, 138, 142, and 148. Operations of the block 718 also include communicating through the user interface of the system 100 an information message about the automatically implemented corrective action(s) to the operator. After completion of the corrective action(s), the method 700 is directed back to the block 704, where the electronic controller 102 configures the system 100 to resume the sorting of the sample S.

FIG. 8 is a block diagram of an example computing device 800 that can be used in the system 100 in accordance with various embodiments. For example, in some embodiments, the computing device 800 performs at least some operations of the electronic controller 102 (also see FIGS. 1A, 1B, and 7). In various embodiments, an electronic support module of the system 100 may be implemented by a single computing device 800 or by multiple computing devices 800. In some parts of this specification, the terms “computing device” and “electronic controller” may be used interchangeably.

The computing device 800 of FIG. 8 is illustrated as having a number of components, but any one or more of these components may be omitted or duplicated, as suitable for the application and setting. In some embodiments, some or all of the components included in the computing device 800 may be attached to one or more motherboards and enclosed in a housing. In some embodiments, some of those components may be fabricated onto a single system-on-a-chip (SoC) (e.g., the SoC may include one or more processing devices 802 and one or more storage devices 804). Additionally, in various embodiments, the computing device 800 may not include one or more of the components illustrated in FIG. 8, but may include interface circuitry for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 800 may not include a display device 810, but may include display device interface circuitry (e.g., a connector and driver circuitry) to which an external display device 810 may be coupled.

The computing device 800 includes a processing device 802 (e.g., one or more processing devices). As used herein, the term “processing device” refers to any device or portion of a device that processes electronic data from registers and/or memory to transform that electronic data into other electronic data that may be stored in registers and/or memory. In various embodiments, the processing device 802 may include one or more digital signal processors (DSPs), application-specific integrated circuits (ASICs), central processing units (CPUs), graphics processing units (GPUs), server processors, or any other suitable processing devices.

The computing device 800 also includes a storage device 804 (e.g., one or more storage devices). In various embodiments, the storage device 804 may include one or more memory devices, such as random-access memory (RAM) devices (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 804 may include memory that shares a die with the processing device 802. In such an embodiment, the memory may be used as cache memory and include embedded dynamic random-access memory (eDRAM) or spin transfer torque magnetic random-access memory (STT-MRAM), for example. In some embodiments, the storage device 804 may include non-transitory computer readable media having instructions thereon that, when executed by one or more processing devices (e.g., the processing device 802), cause the computing device 800 to perform any appropriate ones of the methods disclosed herein below or portions of such methods.

The computing device 800 further includes an interface device 806 (e.g., one or more interface devices 806). In various embodiments, the interface device 806 may include one or more communication chips, connectors, and/or other hardware and software to govern communications between the computing device 800 and other computing devices. For example, the interface device 806 may include circuitry for managing wireless communications for the transfer of data to and from the computing device 800. The term “wireless” and its derivatives may be used to describe circuits, devices, systems, methods, techniques, communications channels, etc., that may communicate data via modulated electromagnetic radiation through a nonsolid medium. The term does not imply that the associated devices do not contain any wires, although in some embodiments they might not. Circuitry included in the interface device 806 for managing wireless communications may implement any of a number of wireless standards or protocols, including but not limited to Institute for Electrical and Electronic Engineers (IEEE) standards including Wi-Fi (IEEE 802.11 family), IEEE 802.16 standards, Long-Term Evolution (LTE) project along with any amendments, updates, and/or revisions (e.g., advanced LTE project, ultramobile broadband (UMB) project (also referred to as “3GPP2”), etc.). In some embodiments, circuitry included in the interface device 806 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 806 for managing wireless communications may operate in accordance with Enhanced Data for GSM Evolution (EDGE), GSM EDGE Radio Access Network (GERAN),

Universal Terrestrial Radio Access Network (UTRAN), or Evolved UTRAN (E-UTRAN). In some embodiments, circuitry included in the interface device 806 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 806 may include one or more antennas (e.g., one or more antenna arrays) configured to receive and/or transmit wireless signals.

In some embodiments, the interface device 806 may include circuitry for managing wired communications, such as electrical, optical, or any other suitable communication protocols. For example, the interface device 806 may include circuitry to support communications in accordance with Ethernet technologies. In some embodiments, the interface device 806 may support both wireless and wired communication, and/or may support multiple wired communication protocols and/or multiple wireless communication protocols. For example, a first set of circuitry of the interface device 806 may be dedicated to shorter-range wireless communications such as Wi-Fi or Bluetooth, and a second set of circuitry of the interface device 806 may be dedicated to longer-range wireless communications such as global positioning system (GPS), EDGE, GPRS, CDMA, WiMAX, LTE, EV-DO, or others. In some other embodiments, a first set of circuitry of the interface device 806 may be dedicated to wireless communications, and a second set of circuitry of the interface device 806 may be dedicated to wired communications.

The computing device 800 also includes battery/power circuitry 808. In various embodiments, the battery/power circuitry 808 may include one or more energy storage devices (e.g., batteries or capacitors) and/or circuitry for coupling components of the computing device 800 to an energy source separate from the computing device 800 (e.g., to AC line power).

The computing device 800 also includes a display device 810 (e.g., one or multiple individual display devices). In various embodiments, the display device 810 may include any visual indicators, such as a heads-up display, a computer monitor, a projector, a touchscreen display, a liquid crystal display (LCD), a light-emitting diode display, or a flat panel display.

The computing device 800 also includes additional input/output (I/O) devices 812. In various embodiments, the I/O devices 812 may include one or more data/signal transfer interfaces, audio I/O devices (e.g., microphones or microphone arrays, speakers, headsets, earbuds, alarms, etc.), audio codecs, video codecs, printers, sensors (e.g., thermocouples or other temperature sensors, humidity sensors, pressure sensors, vibration sensors, etc.), image capture devices (e.g., one or more cameras), human interface devices (e.g., keyboards, cursor control devices, such as a mouse, a stylus, a trackball, or a touchpad), etc.

Depending on the specific embodiment of the system 100, various components of the interface devices 806 and/or I/O devices 812 can be configured to output suitable control signals (e.g., 104, 106, 118, 124, 126, and 148) for various components of the system 100, receive suitable control/telemetry signals from various components of the system 100, and receive streams of measurements (e.g., 142) from various detectors of the system 100. In some examples, the interface devices 806 and/or I/O devices 812 include one or more analog-to-digital converters (ADCs) for transforming received analog signals into a digital form suitable for operations performed by the processing device 802 and/or the storage device 804. In some additional examples, the interface devices 806 and/or I/O devices 812 include one or more digital-to-analog converters (DACs) for transforming digital signals provided by the processing device 802 and/or the storage device 804 into an analog form suitable for being communicated to the corresponding components of the system 100.

According to one example disclosed above, e.g., in the summary section and/or in reference to any one or any combination of some or all of FIGS. 1-8, provided is a method for sorting particles comprising: with a computing device, acquiring event statistics based on one or more signals generated from interrogating the particles in a fluid stream; with the computing device, determining a degree of deviation of the event statistics from reference statistics; and with the computing device, taking an automated responsive action in response to the degree of deviation exceeding a threshold level.

In some examples of the above method, the method further comprises, with the computing device, selecting the responsive action from an ordered list of responsive actions directed at improving a sorting efficiency of the system for the particles.

In some examples of any of the above methods, the method further comprises, with the computing device, determining the degree of deviation, the determining comprising: fitting a distribution of event gaps to a sum including a first component characterized by a first rate parameter and a second component characterized by a second rate parameter that is greater than the first rate parameter; and determining a fraction of the distribution corresponding to the second component.

In some examples of any of the above methods, said taking the responsive action comprises: the computing device stopping sorting operations of the system; and the computing device communicating through a user interface a request for a user intervention.

In some examples of any of the above methods, said taking the responsive action comprises the computing device autonomously making one or more configuration changes in the system via one or more control signals.

In some examples of any of the above methods, the system comprises a sample mixer; and wherein the one or more control signals include a control signal applied to the sample mixer.

In some examples of any of the above methods, the sample mixer includes a vortex mixer; and wherein the one or more control signals include a control signal applied to the vortex mixer.

In some examples of any of the above methods, the system comprises a sheath-fluid mixer; and wherein the one or more control signals include a control signal applied to the sheath-fluid mixer.

In some examples of any of the above methods, the system includes a nozzle actuated with a vibrator to break up the stream of fluid ejected from the nozzle into a stream of droplets; and wherein the one or more control signals include a control signal applied to the vibrator.

In some examples of any of the above methods, the system includes: a first pressure regulator to regulate air pressure in a first container connected to inject the suspension of cells into a central core of the nozzle; and a second pressure regulator to regulate air pressure in a second container connected to inject a sheath fluid into a peripheral portion of the nozzle; and wherein the one or more control signals include at least one of a control signal applied to the first pressure regulator and a control signal applied to the second pressure regulator.

In some examples of any of the above methods, the responsive action comprises the computing device communicating through a user interface a suggested change in the sample or in a configuration of the system.

According to another example disclosed above, e.g., in the summary section and/or in reference to any one or any combination of some or all of FIGS. 1-8, provided is an apparatus, comprising: a fluidics system configured to generate a fluid stream using a sample including a suspension of particles to be sorted, the fluid stream forming a stream of droplets; an optical interrogation system configured to illuminate the fluid stream with probe light and one or more optical detectors configured to convert optical response signals to the probe light received from the fluid stream into electrical signals; and an electronic controller configured to: process the electrical signals to acquire event statistics corresponding to the fluid stream; determine a degree of deviation of the event statistics from reference statistics; and take a responsive action in response to the degree of deviation exceeding a threshold level.

In some examples of the above apparatus, the electronic controller is configured to select the responsive action from an ordered list of responsive actions directed at improving a sorting efficiency of the apparatus for the particles.

In some examples of any of the above apparatus, to determine the degree of deviation, the electronic controller is configured to: fit a distribution of event gaps to a sum including a first component characterized by a first rate parameter and a second component characterized by a second rate parameter that is greater than the first rate parameter; and determine a fraction of the distribution corresponding to the second component.

In some examples of any of the above apparatus, the responsive action comprises: the electronic controller stopping sorting operations of the apparatus; and the electronic controller communicating through a user interface a request for a user intervention.

In some examples of any of the above apparatus, the responsive action comprises the electronic controller autonomously making one or more configuration changes in the apparatus via one or more control signals.

In some examples of any of the above apparatus, the apparatus further comprises a sample mixer, wherein the one or more control signals include a control signal applied to the sample mixer.

In some examples of any of the above apparatus, the sample mixer includes a vortex mixer; and wherein the one or more control signals include a control signal applied to the vortex mixer.

In some examples of any of the above apparatus, the apparatus further comprises a sheath-fluid mixer, wherein the one or more control signals include a control signal applied to the sheath-fluid mixer.

In some examples of any of the above apparatus, the fluidics system includes a nozzle actuated with a vibrator to break up the stream of fluid ejected from the nozzle into the stream of droplets; and wherein the one or more control signals include a control signal applied to the vibrator.

In some examples of any of the above apparatus, the fluidics system includes: a first pressure regulator to regulate air pressure in a first container connected to inject the suspension of cells into a central core of the nozzle; and a second pressure regulator to regulate air pressure in a second container connected to inject a sheath fluid into a peripheral portion of the nozzle; and wherein the one or more control signals include at least one of a control signal applied to the first pressure regulator and a control signal applied to the second pressure regulator.

In some examples of any of the above apparatus, the one or more configuration changes are selected from the group consisting of: configuring a sample mixer to change a composition of a carrier fluid carrying the suspension of cells into a nozzle; configuring a sheath-fluid mixer to change a composition of a sheath fluid injected into the nozzle; activating or deactivating vortexing in the sample mixer; configuring a signal generator to change at least one of a frequency and an amplitude of a vibrator connected to the nozzle; and configuring a pressure-control element to change a flow speed of the carrier fluid or a flow speed of the sheath fluid.

In some examples of any of the above apparatus, the reference statistics is Poisson statistics.

In some examples of any of the above apparatus, the apparatus further comprises a droplet sorting device configured to: separate the stream of droplets into a plurality of sub-streams; and direct one or more sub-streams of the plurality of sub-streams toward one or more respective receptacles.

In some examples of any of the above apparatus, the apparatus further comprises a droplet sorting device configured to apply electrical charges to the stream of fluid and separate the stream of droplets into a plurality of sub-streams by applying a transverse electric field to deflect charged droplets.

According to yet another example disclosed above, e.g., in the summary section and/or in reference to any one or any combination of some or all of FIGS. 1-8, provided is a non-transitory computer-readable medium storing instructions that, when executed by a computing device, cause the computing device to perform operations comprising: acquiring event statistics based on one or more signals generated from interrogating particles in a fluid stream; determining a degree of deviation of the event statistics from reference statistics; and taking an automated responsive action in response to the degree of deviation exceeding a threshold level.

It is to be understood that the above description is intended to be illustrative and not restrictive. Many implementations and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future examples. In sum, it should be understood that the application is capable of modification and variation.

All terms used in the claims are intended to be given their broadest reasonable

constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the

technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed subject matter incorporate more features than are expressly recited in each claim. Rather, as the following claims reflect, inventive subject matter lies in fewer than all features of a single disclosed example. Thus, the following claims are hereby incorporated into the Detailed Description, with each claim standing on its own as a separately claimed subject matter.

Unless explicitly stated otherwise, each numerical value and range should be interpreted as being approximate as if the word “about” or “approximately” preceded the value or range.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. A method for sorting particles, the method comprising:
with a computing device, acquiring event statistics based on one or more signals generated from interrogating the particles in a fluid stream;
with the computing device, determining a degree of deviation of the event statistics from reference statistics; and
with the computing device, taking an automated responsive action in response to the degree of deviation exceeding a threshold level.

2. The method of claim 1, further comprising, with the computing device, selecting the automated responsive action from an ordered list of responsive actions directed at improving a cell-sorting efficiency for the particles.

3. The method of claim 1, wherein the determining comprises:
fitting a distribution of event gaps to a sum including a first component characterized by a first rate parameter and a second component characterized by a second rate parameter that is greater than the first rate parameter; and
determining a fraction of the distribution corresponding to the second component.

4. The method of claim 1, wherein the taking the automated responsive action comprises:
the computing device stopping sorting operations; and
the computing device communicating through a user interface a request for a user intervention.

5. The method of claim 1, wherein the taking the automated responsive action comprises the computing device autonomously making one or more configuration changes in a corresponding system via one or more control signals.

6. The method of claim 5,
wherein the corresponding system comprises a sample mixer; and
wherein the one or more control signals include a control signal applied to the sample mixer.

7. The method of claim 6,
wherein the sample mixer includes a vortex mixer; and
wherein the one or more control signals include a control signal applied to the vortex mixer.

8. The method of claim 5,
wherein the corresponding system comprises a sheath-fluid mixer; and
wherein the one or more control signals include a control signal applied to the sheath-fluid mixer.

9. The method of claim 5,
wherein the corresponding system includes a nozzle actuated with a vibrator to break up a stream of fluid ejected from the nozzle into a stream of droplets; and
wherein the one or more control signals include a control signal applied to the vibrator.

10. The method of claim 9,
wherein the corresponding system includes:
a first pressure regulator to regulate air pressure in a first container connected to inject the particles into a central core of the nozzle; and
a second pressure regulator to regulate air pressure in a second container connected to inject a sheath fluid into a peripheral portion of the nozzle; and
wherein the one or more control signals include at least one of a control signal applied to the first pressure regulator and a control signal applied to the second pressure regulator.

11. The method of claim 1, wherein the taking the automated responsive action comprises the computing device communicating through a user interface a suggested change in a sample containing the particles or in a configuration of a corresponding system.

12. An apparatus, comprising:
a fluidics system configured to generate a fluid stream using a sample including a suspension of particles to be sorted, the fluid stream forming a stream of droplets;
an optical interrogation system configured to illuminate the fluid stream with probe light and one or more optical detectors configured to convert optical response signals to the probe light received from the fluid stream into electrical signals; and
an electronic controller configured to:
process the electrical signals to acquire event statistics corresponding to the fluid stream;
determine a degree of deviation of the event statistics from reference statistics; and
take a responsive action in response to the degree of deviation exceeding a threshold level.

13. The apparatus of claim 12, wherein, to determine the degree of deviation, the electronic controller is configured to:
fit a distribution of event gaps to a sum including a first component characterized by a first rate parameter and a second component characterized by a second rate parameter that is greater than the first rate parameter; and
determine a fraction of the distribution corresponding to the second component.

14. The apparatus of claim 12, wherein the responsive action comprises the electronic controller autonomously making one or more configuration changes in the apparatus via one or more control signals.

15. The apparatus of claim 14, further comprising a sample mixer,
wherein the one or more control signals include a control signal applied to the sample mixer.

16. The apparatus of claim 15,
wherein the sample mixer includes a vortex mixer; and
wherein the one or more control signals include a control signal applied to the vortex mixer.

17. The apparatus of claim 14, further comprising a sheath-fluid mixer,
wherein the one or more control signals include a control signal applied to the sheath-fluid mixer.

18. The apparatus of claim 14,
wherein the fluidics system includes a nozzle actuated with a vibrator to break up a stream of fluid ejected from the nozzle into the stream of droplets; and
wherein the one or more control signals include a control signal applied to the vibrator.

19. A non-transitory computer-readable medium storing instructions that, when executed by a computing device, cause the computing device to perform operations comprising:
acquiring event statistics based on one or more signals generated from interrogating particles in a fluid stream;
determining a degree of deviation of the event statistics from reference statistics; and
taking an automated responsive action in response to the degree of deviation exceeding a threshold level.

20. The non-transitory computer-readable medium of claim 19, wherein taking the automated responsive action includes autonomously making one or more configuration changes in an apparatus via one or more control signals, wherein the one or more configuration changes are selected from a group consisting of:
configuring a sample mixer to change a composition of a carrier fluid carrying the particles into a nozzle;
configuring a sheath-fluid mixer to change a composition of a sheath fluid injected into the nozzle;
activating or deactivating vortexing in the sample mixer;
configuring a signal generator to change at least one of a frequency and an amplitude of a vibrator connected to the nozzle; and
configuring a pressure-control element to change a flow speed of the carrier fluid or a flow speed of the sheath fluid.
